(19) United States
(12) Patent Application Publication
(10) Pub. No.: US 2019/0073540 A1
(43) Pub. Date: Mar. 7, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Hiroyuki Yamada, Wako-shi (JP); Makoto Katayama, Wako-shi (JP)

(21) Appl. No.: 16/114,282

(22) Filed: Aug. 28, 2018

(30) Foreign Application Priority Data
Sep. 7, 2017 (JP) 2017-172430

(51) Int. Cl. G06K 9/00; G08G 1/16; G06T 7/73; B60W 50/16

(52) U.S. Cl. CPC G06K 9/00798; G08G 1/167; G06K 9/00825; G01S 17/936; B60W 50/16; G06T 2207/30256; G06T 7/73

(57) ABSTRACT

A vehicle control device includes: a recognition unit recognizing a horizontal position of a subject vehicle with respect to a lane in which the subject vehicle is running; and an other-vehicle monitoring control unit executing a predetermined operation in a case in which a state of another vehicle present on a rear side of the subject vehicle satisfies a predetermined condition and changing the predetermined condition on the basis of the horizontal position recognized by the recognition unit.

### CROSS-REFERENCE TO RELATED APPLICATION

Priority is claimed on Japanese Patent Application No. 2017-172430, filed on Sep. 7, 2017, the content of which is incorporated herein by reference.

### BACKGROUND OF THE INVENTION

### Field of the Invention

The present invention relates to a vehicle control device, a vehicle control method, and a storage medium.

### Description of Related Art

Conventionally, technologies for detecting a vehicle running ahead in the same lane using a radar sensor mounted in a vehicle to automatically driving a vehicle following a detected vehicle running ahead of it are known (Japanese Unexamined Patent Application, First Publication No. H4-258780). In the technology disclosed in Patent Document 1, displacement of a vehicle with reference to a lane extracted from an image of a road surface imaged by a camera mounted in the vehicle is calculated, and a correction is made such that a detection range of a radar sensor is directed toward the center of the lane on the basis of the calculated displacement.

### SUMMARY OF THE INVENTION

However, according to the conventional technology, a radar angle directed toward the direction of the front side of the vehicle is corrected, but a range for detecting a vehicle present on the rear side is not changed. Accordingly, there are cases in which another vehicle on the rear side is erroneously detected, or another vehicle that should be detected cannot be detected.

An aspect of the present invention is in view of such situations, and one object thereof is to provide a vehicle control device a vehicle control method, and a storage medium capable of detecting other vehicles in an appropriate range on the rear side of a subject vehicle.

A vehicle control device, a vehicle control method, and a storage medium according to the present invention employ the following configurations.

(1) According to one aspect of the present invention, there is provided a vehicle control device including a recognition unit recognizing a horizontal position of a subject vehicle with respect to a lane in which the subject vehicle is running; and an other-vehicle monitoring control unit executing a predetermined operation in a case in which a state of another vehicle present on a rear side of the subject vehicle satisfies a predetermined condition and changing the predetermined condition on the basis of the horizontal position recognized by the recognition unit.

(2) In the aspect (1) described above, the predetermined condition includes presence of the other vehicle inside a predetermined area set on a rear side of the subject vehicle, and the other-vehicle monitoring control unit changes a form of the predetermined area on the basis of the horizontal position.

(3) In the aspect (2) described above, the predetermined area is set on each of left and right rear sides of the subject vehicle, and the other-vehicle monitoring control unit changes the predetermined area on the same side as a side to which the horizontal position deviates as being decreased and changes the predetermined area on the opposite side as being increased.

(4) In the aspect (2) described above, the other-vehicle monitoring control unit changes forms of the predetermined areas such that the predetermined area set on each of the left and right rear sides of the subject vehicle covers a lane adjacent to a lane in which the subject vehicle is running in a widthwise direction.

(5) In the aspect (2) described above, in a case in which a plurality of other vehicles are present in the predetermined area, the other-vehicle monitoring control unit sets a vehicle among the other vehicles that is closest to the subject vehicle as a monitoring target.

(6) In the aspect (2) described above, the recognition unit recognizes the number of lanes in which the subject vehicle is running, and, in a case in which the number of lanes recognized by the recognition unit is three or more, the other-vehicle monitoring control unit changes a form of the predetermined area on the basis of the horizontal position recognized by the recognition unit.

(7) In the aspect (2) described above, a storage device in which map information is stored and a navigation device outputting information relating to a route to a destination of the subject vehicle on the basis of the map information stored in the storage device are further included, and the other-vehicle monitoring control unit acquires the number of lanes in which the subject vehicle is running from the map information and, in a case in which the acquired number of lanes is three or more, changes a form of the predetermined area on the basis of the horizontal position recognized by the recognition unit.

(8) In the aspect (2) described above, an imaging unit imaging a lane in which the subject vehicle is running is further included, and the other-vehicle monitoring control unit estimates a width of a lane adjacent to a lane in which the subject vehicle is running on the basis of an image captured by the imaging unit and changes a form of the predetermined area on the basis of the estimated width of the adjacent lane.

(9) According to one aspect of the present invention, there is provided a vehicle control method executed by a computer mounted in a subject vehicle, the vehicle control method including: recognizing a horizontal position of the subject vehicle with respect to a lane in which the subject vehicle is running; executing a predetermined operation in a case in which a state of another vehicle present on a rear side of the subject vehicle satisfies a predetermined condition; and changing the predetermined condition on the basis of the recognized horizontal position.

(10) According to one aspect of the present invention, there is provided a computer-readable non-transitory storage medium having a program stored thereon, the program causing an in-vehicle computer to execute: recognizing a horizontal position of the subject vehicle with respect to a lane in which the subject vehicle is running; executing a predetermined operation in a case in which a state of another vehicle present on a rear side of the subject vehicle satisfies a predetermined condition; and changing the predetermined condition on the basis of the recognized horizontal position.

According to the aspects (1) to (10) described above, other vehicles in an appropriate range on the rear side of a subject vehicle can be detected.

### BRIEF DESCRIPTION OF THE DRAWINGS

FIG. 1 is a configuration diagram of a vehicle control system including a vehicle control device according to an embodiment;

FIG. 2 is a diagram showing one example of a vehicle cabin of a case in which a subject vehicle is seen from above;

FIG. 3 is a diagram showing one example of a door mirror;

FIG. 4 is a diagram showing a view in which a relative position and a posture of a subject vehicle M with respect to a running lane are recognized by a subject vehicle position recognizing unit;

FIG. 5 is a functional configuration diagram of an other-vehicle monitoring control unit;

FIG. 6 is a diagram showing one example of monitoring areas;

FIG. 7 is a diagram showing a view in which the forms of a left rear-side area and a right rear-side area are changed in a case in which a horizontal position of a subject vehicle deviates to the left side from the running lane center CL;

FIG. 8 is a diagram showing a change in the form of a right rear-side area in a case in which a subject vehicle runs on a three-lane road;

FIG. 9 is a diagram showing a view in which a plurality of other vehicles are present inside a right rear area;

FIG. 10 is a diagram showing control details of driving support control in a situation in which another vehicle approaches from the rear side of a subject vehicle in an adjacent lane;

FIG. 11 is a diagram showing a view of running of a subject vehicle at a time t2;

FIG. 12 is a flowchart showing one example of the flow of a vehicle control process according to an embodiment;

FIG. 13 is a flowchart showing one example of a detailed flow of a vehicle control process according to an embodiment; and

FIG. 14 is a diagram showing one example of the hardware configuration of a vehicle control device according to an embodiment.

### DETAILED DESCRIPTION OF THE INVENTION

Hereinafter, a vehicle control device, a vehicle control method, and a storage medium according to embodiments of the present invention will be described with reference to the drawings. Hereinafter, although a case in which a rule of left traffic is applied will be described, the left side and the right side may be interchanged in a case in which a rule of right traffic is applied.

### [Entire Configuration]

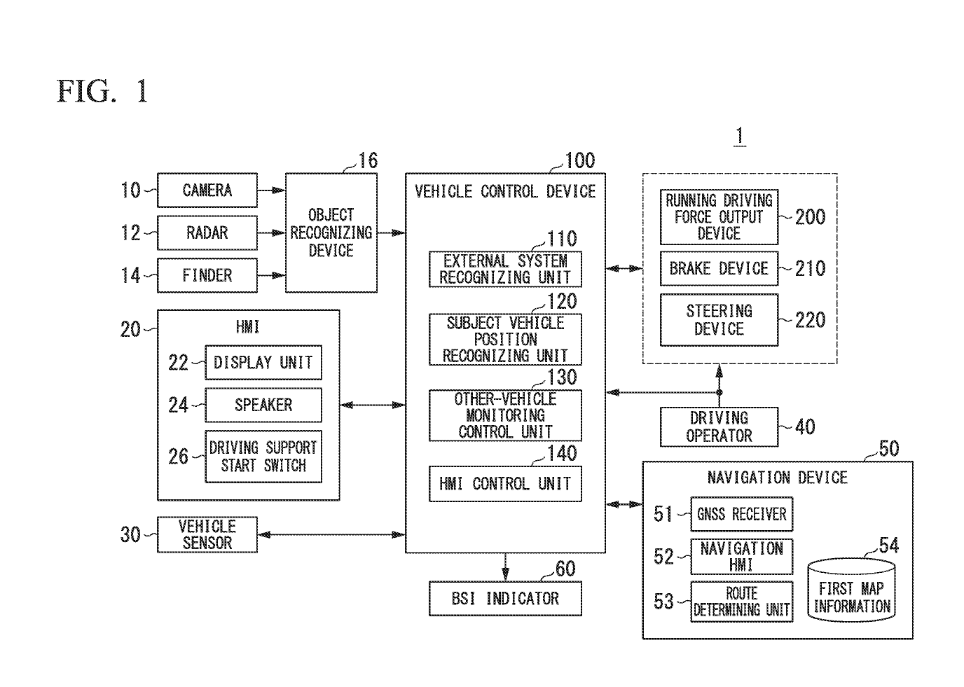

FIG. 1 is a configuration diagram of a vehicle control system 1 including a vehicle control device according to an embodiment. A vehicle in which the vehicle control system 1 is mounted (hereinafter referred to as a subject vehicle M) is, for example, a vehicle having two wheels, three wheels, four wheels, or the like, and a driving source thereof is an internal combustion engine such as a diesel engine or a gasoline engine, an electric motor, or a combination thereof. The electric motor operates using power generated using a power generator connected to an internal combustion engine or discharge power of a secondary cell or a fuel cell.

The vehicle control system 1, for example, includes a camera (imaging unit) 10, a radar 12, a finder 14, an object recognizing device 16, a human machine interface (HMI) 20, a vehicle sensor 30, a driving operator 40, a navigation device 50, a blind spot information (BSI) indicator 60, a vehicle control device 100, a running driving force output device 200, a brake device 210, and a steering device 220. Such devices and units are interconnected using a multiplex communication line such as a controller area network (CAN) communication line, a serial communication line, a radio communication network, or the like. The configuration illustrated in FIG. 1 is merely one example, and thus parts of the configuration may be omitted and other components may be further added.

The camera 10, for example, is a digital camera using a solid-state imaging device such as a charge coupled device (CCD) or a complementary metal oxide semiconductor (CMOS). One or a plurality of cameras 10 are installed at arbitrary places on the subject vehicle M. For example, in a case in which the side in front is to be imaged, the camera 10 is installed at an upper part of a front windshield, a rear face of a rear-view mirror, or the like. The camera 10, for example, repeatedly images the vicinity of the subject vehicle M periodically. The camera 10 may be a stereo camera.

The radar 12 emits radio waves such as millimeter waves to the vicinity of the subject vehicle M and detects at least a position (a distance and an azimuth) of an object by detecting radio waves (reflected waves) reflected by the object. One or a plurality of radars 12 are installed at arbitrary places on the subject vehicle M. The radar 12 may detect a position and a speed of an object using a frequency modulated continuous wave (FM-CW) system.

The finder 14 is a light detection and ranging or laser imaging detection and ranging (LIDAR) device that detects a distance to a target by measuring scattered light from emitted light. One or a plurality of finders 14 are installed at arbitrary places on the subject vehicle M.

The object recognizing device 16 performs a sensor fusion process on results of detection using some or all of the camera 10, the radar 12, and the finder 14, thereby recognizing a position, a type, a speed, a movement direction, and the like of an object. Objects to be recognized, for example, are objects of types such as a vehicle, a guard rail, a telegraph pole, a pedestrian, and a road mark. The object recognizing device 16 may extract partition lines (white lines) on a road surface from an image captured by the camera 10 and recognize a lane using the extracted partition lines. The object recognizing device 16 outputs a result of the recognition to the vehicle control device 100. The object recognizing device 16 may directly output a part of information input from the camera 10, the radar 12, or the finder 14 to the vehicle control device 100.

The HMI 20 presents various types of information to a vehicle occupant of the subject vehicle M and receives an input operation performed by the vehicle occupant. The HMI 20, for example, may include a display unit 22, a speaker 24, various buttons such as a driving support start switch 26, a microphone, a buzzer, and the like. Each device of the HMI 20, for example, is installed at each unit of an instrument panel or an arbitrary place on a front passenger seat or a rear seat.

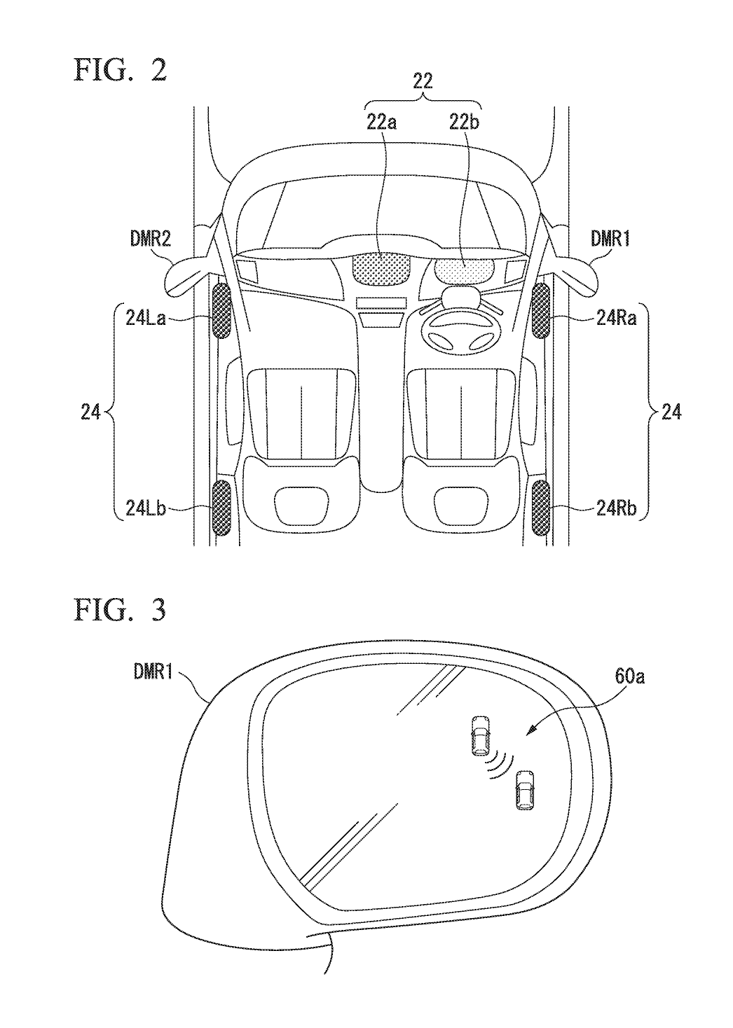

FIG. 2 is a diagram showing one example of a vehicle cabin of a case in which a subject vehicle M is seen from above. As illustrated in the drawing, for example, the display unit 22 is positioned below the front windshield and is mounted in a dashboard disposed in front of a driver's seat and a front passenger seat (22a illustrated in the drawing). The display unit 22, for example, is disposed in front of the driver's seat (22b in the drawing) and may function also as an instrument panel displaying meters such as a speed meter and a tachometer.

The display unit 22, for example, is one of various display devices such as a liquid crystal display (LCD) or an organic electroluminescence (EL) display. The display unit 22 displays an image output by a notification control unit 133 or an HMI control unit 140 to be described later. The display unit 22 may be a touch panel that receives an operation on a screen from a vehicle occupant.

The speakers 24, for example, are mounted at a position near a door closest to the front passenger seat (24La in the drawing), a position near a door closest to the driver's seat (24Ra in the drawing), a position near a door closest to a rear passenger seat behind the front passenger seat (24Lb in the drawing), and a position near a door closest to a rear passenger seat behind the driver's seat (24Rb in the drawing). The speakers 24, for example, output speech, a warning sound, and the like under the control of the notification control unit 133 or the HMI control unit 140.

The driving support start switch 26 is a switch that is used for causing the vehicle control device 100 to start driving support control. The driving support control, for example, is a control state in which both the running driving force output device 200 and the brake device 210, only the steering device 220, or all of the running driving force output device 200, the brake device 210, and the steering device are controlled. In a case in which the driving support start switch 26 is not operated, in other words, in a case in which the vehicle control device 100 does not execute driving support control, manual driving is performed. In the manual driving, the running driving force output device 200, the brake device 210, and the steering device 220 are controlled in accordance with the amount of operation for the driving operator 40 performed by the vehicle occupant.

The vehicle sensor 30, for example, includes a vehicle speed sensor that detects a speed of the subject vehicle M, an acceleration sensor that detects an acceleration, a yaw rate sensor that detects an angular velocity (yaw rate) of the center of gravity of the subject vehicle M around a vertical axis, an azimuth sensor that detects the azimuth of the subject vehicle M, and the like. The speed, for example, includes at least one of a longitudinal speed relating to the advancement direction of the subject vehicle M and a lateral speed relating to the horizontal direction of the subject vehicle M. The acceleration, for example, includes at least one of a vertical acceleration relating to the advancement direction of the subject vehicle M and a horizontal acceleration relating to the horizontal direction of the subject vehicle M. Each sensor included in the vehicle sensor 30 outputs a detection signal representing a result of detection to the vehicle control device 100.

The driving operator 40, for example, includes various operators such as a steering wheel on which a vehicle occupant performs a steering operation, a turn signal lever operating a turn signal (direction indicator), an acceleration pedal, a brake pedal, and a shift lever. For example, an operation detecting unit that detects an amount of an operation performed by a vehicle occupant is installed in each operator of the driving operator 40. The operation detecting units detect a position of the turn signal lever, the amounts of depression of the acceleration pedal and the brake pedal, a position of the shift lever, a steering angle and a steering torque of the steering wheel, and the like. Then, the operation detecting units output detection signals representing results of detection to the vehicle control device 100 or one or two of the running driving force output device 200, the brake device 210, and the steering device 220.

The navigation device 50, for example, includes a global navigation satellite system (GNSS) receiver 51, a navigation HMI 52, and a route determining unit 53 and stores first map information 54 in a storage device such as a hard disk drive (HDD) or a flash memory. The GNSS receiver 51 identifies a position of a subject vehicle M on the basis of signals received from GNSS satellites. The position of the subject vehicle M may be identified or complemented by an inertial navigation system (INS) using an output of the vehicle sensor 30. The navigation HMI 52 includes a display device, a speaker, a touch panel, a key, and the like. A part or the whole of the navigation HMI 52 may be shared with the HMI 20. The route determining unit 53, for example, determines a route from a location of the subject vehicle M identified by the GNSS receiver 51 (or an input arbitrary location) to a destination input by a vehicle occupant using the navigation HMI 52 (for example, including information relating to a transit point when the subject vehicle runs to the destination) by referring to the first map information 54.

The first map information 54, for example, is information in which a road form is represented by respective links representing a road and respective nodes connected using the links. The first map information 54, for example, includes information of centers of respective lanes, information on boundaries between lanes, or the like. In addition, in the first map information 54, road information, traffic regulation information, address information (an address and a zip code), facility information, telephone information, and the like may be included. In the road information, information representing a type of road such as an expressway and a toll road, a local road, or a prefectural road and information such as a reference speed of a road, the number of lanes, a width of each lane, a gradient of a road, a location of a road (three-dimensional coordinates including a longitude, a latitude and a height), a curvature of a curve of a road or each lane of a road, locations of merging and branching points of lanes, a sign installed on a road, and the like are included. The reference speed, for example, is a legal speed, an average speed of a plurality of vehicles that have run on the road in the past, or the like. The navigation device 50 performs route guidance using the navigation HMI 52 on the basis of the route determined by the route determining unit 53.

The BSI indicator 60, for example, displays a predetermined image 60a on a part of a glass surface of a door mirror DMR. The door mirror DMR, for example, is disposed in the door closest to the driver's seat and the door closet to the front passenger seat (door mirrors DMR1 and DMR2 in the drawing). The predetermined image 60a, for example, is an image that is used for notifying a vehicle occupant of approach of another vehicle to the subject vehicle M or estimation of approach at a certain time point in the future.

FIG. 3 is a diagram showing one example of the door mirror DMR1. As illustrated in the example, the predetermined image 60a indicating approach of another vehicle to the subject vehicle M is displayed in a part of the mirror surface of the door mirror DMR1. Similarly, the image 60a is displayed also in the door mirror DMR2.

Before description of the vehicle control device 100, the running driving force output device 200, the brake device 210, and the steering device 220 will be described. The running driving force output device 200 outputs a running driving force (torque) used for enabling the subject vehicle M to run to driving wheels. The running driving force output device 200, for example, includes a combination of an internal combustion engine, an electric motor, a transmission, and the like and a power electronic control unit (ECU) controlling these components. The power ECU controls the components described above in accordance with information input from the vehicle control device 100 or information input from the driving operator 40.

The brake device 210, for example, includes a brake caliper, a cylinder that delivers hydraulic pressure to the brake caliper, an electric motor that generates hydraulic pressure in the cylinder, and a brake ECU. The brake ECU performs control of the electric motor in accordance with information input from the vehicle control device 100 or information input from the driving operator 40 such that a brake torque according to a brake operation is output to each vehicle wheel. The brake device 210 may include a mechanism delivering hydraulic pressure generated in accordance with an operation on the brake pedal included in the driving operators 40 to the cylinder through a master cylinder as a backup. The brake device 210 is not limited to the configuration described above and may be an electronically controlled hydraulic brake device that delivers hydraulic pressure in the master cylinder to a cylinder by controlling an actuator in accordance with information input from the vehicle control device 100.

The steering device 220, for example, includes a steering ECU and an electric motor. The electric motor, for example, changes the direction of the steering wheel by applying a force to a rack and pinion mechanism. The steering ECU changes the direction of the steering wheel by driving an electric motor in accordance with information input from the vehicle control device 100 or information input from the driving operator 40.

### [Configuration of Vehicle Control Device]

The vehicle control device 100, for example, includes an external system recognizing unit 110, a subject vehicle position recognizing unit 120, an other-vehicle monitoring control unit 130, and an HMI control unit 140. These constituent elements, for example, are realized by a hardware processor such as a central processing unit (CPU) executing a program (software). Some or all of these constituent elements may be realized by hardware (a circuit unit; including circuitry) such as a large scale integration (LSI), an application specific integrated circuit (ASIC), a field-programmable gate array (FPGA), or a graphics processing unit (GPU) or may be realized by cooperation between software and hardware. These constituent elements may be realized by one processor or may be realized by a plurality of processors. In the latter case, for example, the vehicle control device 100 may be a system acquired by combining a plurality of electronic control units (ECUs). The subject vehicle position recognizing unit 120 is one example of a “recognition unit.”

The external system recognizing unit 110 recognizes states of other vehicles present in the vicinity of the subject vehicle M such as positions, speeds, and accelerations on the basis of information input from the camera 10, the radar 12, and the finder 14 through the object recognizing device 16. The position of each of the other vehicles may be represented as a representative point on each of the other vehicles such as the center of gravity, a corner, or the like and may be represented by an area represented by the contour of each of the other vehicles. The “state” of each of the other vehicles may include an acceleration or a jerk or is an “action state” (for example, the vehicle is changing or intends to change lanes) of each of the other vehicles. The external system recognizing unit 110 may recognize states of different types of objects such as a guard rail, a telegraph pole, a parked vehicle and a pedestrian in addition to the other vehicles.

The subject vehicle position recognizing unit 120 identifies a position of a subject vehicle M on the basis of signals received by a global navigation satellite system (GNSS) receiver (not illustrated in the drawing) from GNSS satellites. The position of the subject vehicle M may be identified or complemented by an inertial navigation system (INS) using an output of the vehicle sensor 30. The subject vehicle position recognizing unit 120, for example, recognizes a lane in which the subject vehicle M is running (running lane) and a relative position and a posture of the subject vehicle M with respect to the running lane. The subject vehicle position recognizing unit 120, for example, recognizes partition lines LM of a road from an image captured by the camera 10 and recognizes a lane partitioned by two partition lines LM closest to the subject vehicle M among the recognized partition lines LM as a running lane. Then, the subject vehicle position recognizing unit 120 recognizes a position and a posture of the subject vehicle M with respect to the recognized running lane. The subject vehicle position recognizing unit 120 recognizes the number of lanes having the same advancement direction from the number of the partition lines LM.

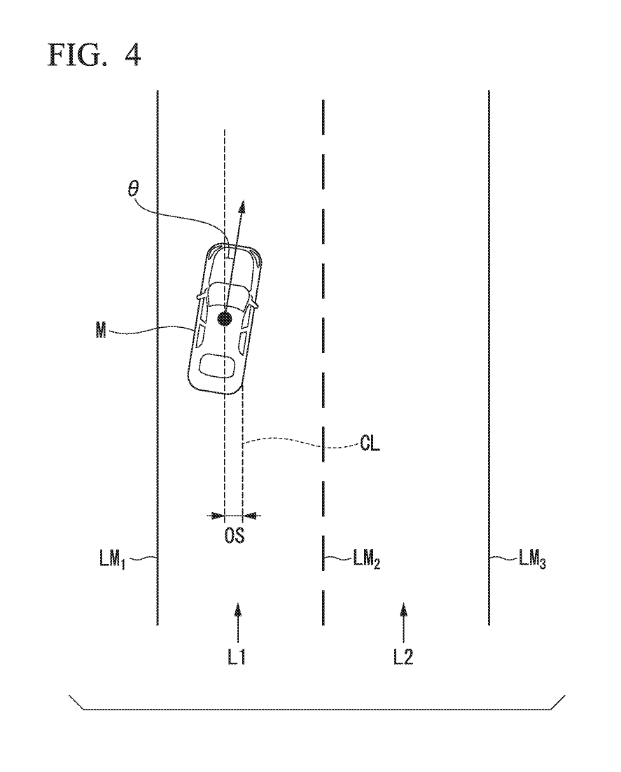

FIG. 4 is a diagram showing a view in which a relative position and a posture of a subject vehicle M with respect to a running lane L1 are recognized by a subject vehicle position recognizing unit 120. The subject vehicle position recognizing unit 120, for example, recognizes partition lines LM1 to LM3 and recognizes an area between the partition lines LM1 and LM2 closest to the subject vehicle M as a running lane (own lane) L1 of the subject vehicle M. Then, the subject vehicle position recognizing unit 120 recognizes an offset OS of a reference point (for example, the center of gravity) of the subject vehicle M from running lane center CL as a relative position in a widthwise direction (hereinafter, referred to as a “horizontal position”). Instead of this, the subject vehicle position recognizing unit 120 may recognize a position of the reference point of the subject vehicle M with respect to one side end portion of the running lane L1 or the like as a horizontal position of the subject vehicle M with respect to the running lane. The subject vehicle position recognizing unit 120 recognizes an angle θ formed by the advancement direction of the subject vehicle M with respect to a continuation line of the running lane center CL as a posture of the subject vehicle M with respect to the running lane L1.

The subject vehicle position recognizing unit 120 may recognize a relative distance and a relative speed between the subject vehicle M and the other vehicle or any other object on the basis of the position and the speed of the subject vehicle M, which have been recognized, and the position and the speed of the other vehicle or the other object recognized by the external system recognizing unit 110.

The subject vehicle position recognizing unit 120, for example, may recognize an adjacent lane that is adjacent to the own lane. For example, the subject vehicle position recognizing unit 120 recognize an area between a partition line closest to the subject vehicle M after the partition lines of the own lane and the partition line of the own lane of the subject vehicle as an adjacent lane. In the example illustrated in FIG. 4, the subject vehicle position recognizing unit 120 recognizes an area between a partition line LM2 of the own lane and a partition line LM3 closest to the subject vehicle M after the partition line LM2 as a right-side adjacent lane L2.

The other-vehicle monitoring control unit 130 executes a predetermined operation in a case in which the state of the other vehicle present in the vicinity of the subject vehicle M satisfies a predetermined condition. The predetermined condition, for example, includes presence of the other vehicle inside a predetermined area disposed on the rear side of the subject vehicle M. The predetermined condition may include approach between a surrounding vehicle and the subject vehicle M and may include a likelihood of a contact between a surrounding vehicle and the subject vehicle M. The approach represents that a relative distance becomes short as being a predetermined pace or more. The predetermined operation, for example, is one or both of an operation relating to a notification to a vehicle occupant and an operation relating to driving support such as contact avoidance or any other operation. The predetermined area, for example, is a monitoring area set in advance.

The other-vehicle monitoring control unit 130 changes the predetermined condition on the basis of a horizontal position recognized by the subject vehicle position recognizing unit 120. Details of the function of the other-vehicle monitoring control unit 130 will be described later.

The HMI control unit 140 outputs an image directed by the vehicle control device 100 to a display device of the HMI 20 or the like. The HMI control unit 140 acquires details of operations and the like of a vehicle occupant received using the display unit 22 of the HMI 20, various buttons, or the like.

### [Configuration of Other-Vehicle Monitoring Control Unit]

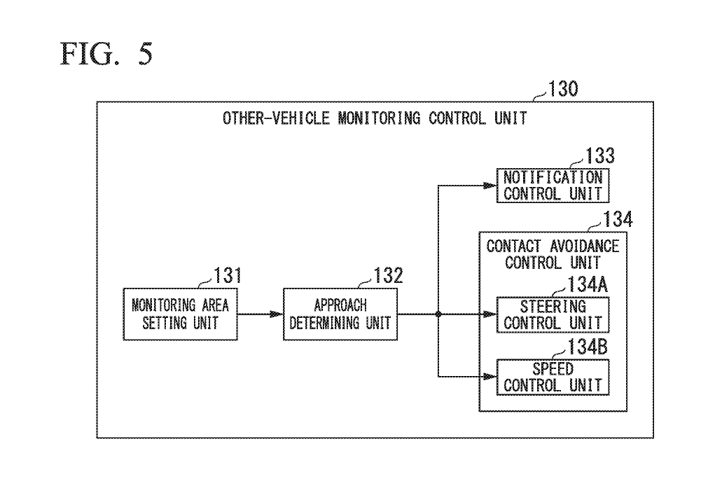

Next, an example of the functional configuration of the other-vehicle monitoring control unit 130 will be described. FIG. 5 is a functional configuration diagram of the other-vehicle monitoring control unit 130. The other-vehicle monitoring control unit 130, for example, includes a monitoring area setting unit 131, an approach determining unit 132, a notification control unit 133, and a contact avoidance control unit 134.

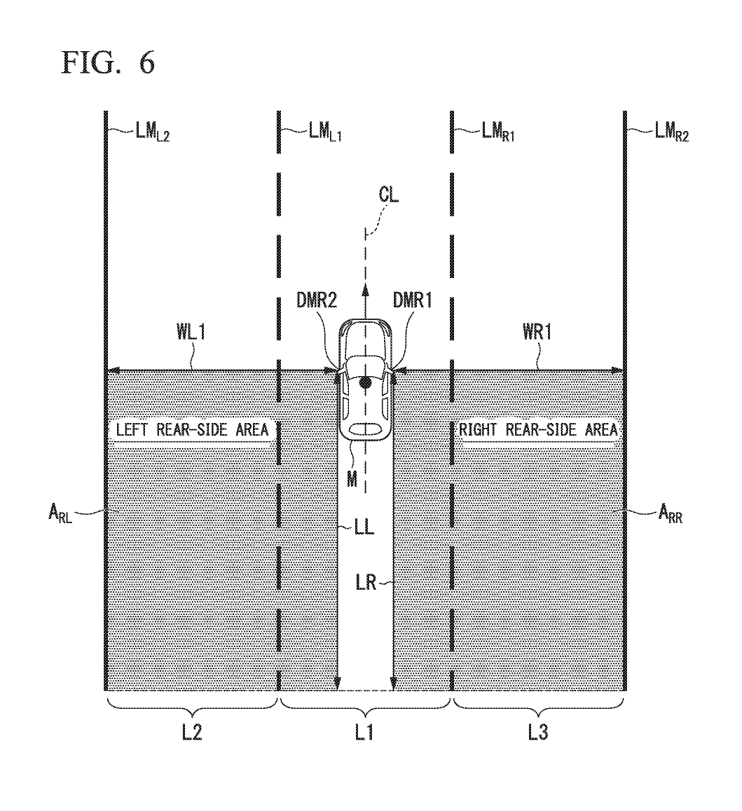

The monitoring area setting unit 131 sets monitoring areas on the basis of the position of the subject vehicle M in a running lane. The monitoring areas, for example, are ranges on the rear side of the subject vehicle M. FIG. 6 is a diagram showing one example of monitoring areas. In the drawing, a lane L1 represents a center lane among three lines, a lane L2 represents a left lane among the three lanes, and a lane L3 represents a right lane among the three lanes. The monitoring area setting unit 131 acquires information of the number of lanes and a lane in which the subject vehicle M is running by referring to the first map information 54 of the navigation device 50 from the position information of the subject vehicle M recognized by the subject vehicle position recognizing unit 120. The monitoring area setting unit 131 may acquire the information of the number of lanes and a lane in which the subject vehicle M is running on the basis of the number and the positions of partition lines LM included in an image captured by the camera 10.

For example, in a case in which the subject vehicle M is running in the lane L1, the monitoring area setting unit 131 sets left and right rear-side areas A_{RL}, and A_{RR} (rear lateral side areas) as monitoring areas in its own lane L1 and adjacent lanes L2 and L3 of the own lane L1.

For example, in a case in which the horizontal position of the subject vehicle M is the running lane center CL of the own lane L1, the left rear-side area A_{RL} is an area having a predetermined width WL1 from the position of the door mirror DMR2 disposed on the left side to the left side with respect to the advancement direction of the subject vehicle M and a predetermined length LL from the position of the door mirror DMR2 to the rear side of the subject vehicle M. For example, in a case in which the horizontal position of the subject vehicle M is the running lane center CL of the own lane L1, the right rear-side area A_{RR} is an area having a width WR1 from the position of the door mirror DMR1 disposed on the right side to the right side with respect to the advancement direction of the subject vehicle M and a predetermined length LR from the position of the door mirror DMR1 to the rear side of the subject vehicle M. In a case in which the subject vehicle M runs at the running lane center CL of the own lane L1, the width WL1 described above reaches a partition line LM_{L2} disposed on a side away from the subject vehicle M out of partition lines partitioning the adjacent lane L2. In a case in which the subject vehicle M runs at the running lane center CL of the own lane L1, the width WR1 reaches a partition line LM_{R2} disposed on a side away from the subject vehicle M out of partition lines partitioning the adjacent lane L3.

Here, in a case in which the horizontal position of the subject vehicle M deviates to one of the left side or the right side from the running lane center CL, the monitoring area setting unit 131 changes the forms of the left rear-side area A_{RL} and the right rear-side area A_{RR}. The changing of the forms of the areas, for example, is changing one or both of the width and the length of each of the left rear-side area A_{RL} and the right rear-side area A_{RR}. The changing of the forms may be enlarging or contracting the left rear-side area A_{RL} and the right rear-side area A_{RR} or sliding the left and right rear-side areas in one direction of the upper, lower, left, and right sides by a predetermined distance.

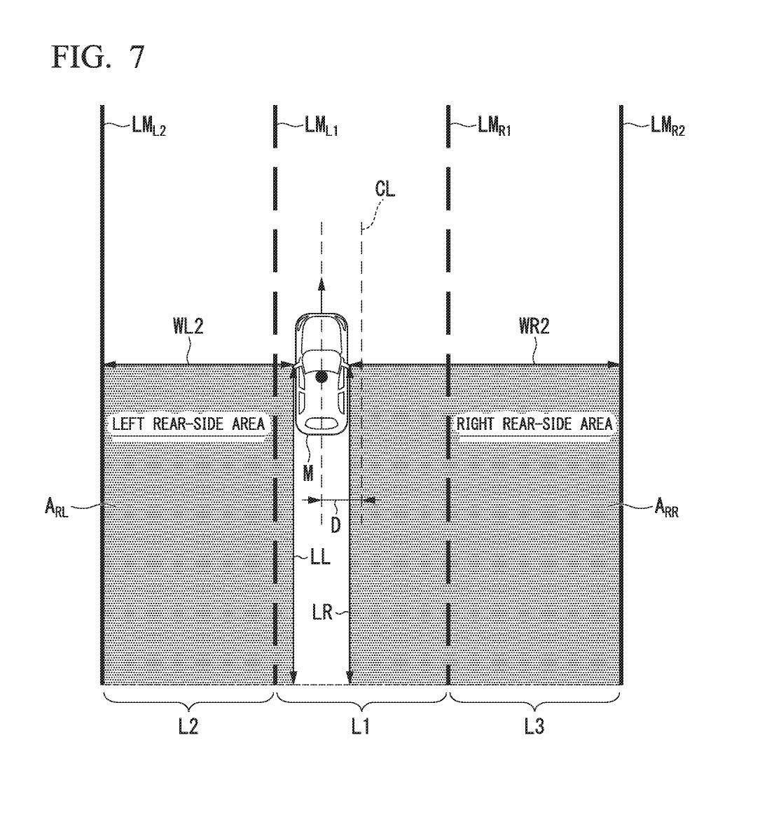

FIG. 7 is a diagram showing a view in which the forms of a left rear-side area A_{RL} and a right rear-side area A_{RR} are changed in a case in which a horizontal position of a subject vehicle M deviates to the left side from running lane center CL. In the example illustrated in FIG. 7, the horizontal position of the subject vehicle M during running deviates from the running lane center CL of its own lane L1 to the left side by a distance D. In this case, the monitoring area setting unit 131 adjusts a width WL1 of the left rear-side area A_{RL} and a width WR1 of the right rear-side area A_{RR} on the basis of the distance D.

For example, the monitoring area setting unit 131 sets a value acquired by subtracting the distance D from a width WL1 during running of the subject vehicle M at the running lane center CL as a width WL2 of the left rear-side area ARL. In addition, the monitoring area setting unit 131 sets a value acquired by adding the distance D to a width WR1 during running of the subject vehicle M at the running lane center CL as a width WR2 of the right rear-side area ARR.

In this way, the monitoring area setting unit 131 changes a monitoring area disposed on the same side as the side, to which the horizontal position of the subject vehicle M deviates, as being decreased and changes a monitoring area disposed on the opposite side as being increased. The monitoring area setting unit 131 changes the forms of monitoring areas such that monitoring areas set in the left and right rear sides of the subject vehicle M covers lanes L2 and L3 adjacent to the own lane L1 of the subject vehicle M in a widthwise direction. Thus, according to the embodiment, by changing the monitoring areas on the rear side on the basis of the horizontal position of the subject vehicle M in the own lane L1, it can be suppressed that other vehicles running in a lane positioned from the own lane L1 to the left side by two lanes (a lane adjacent to a left adjacent lane) are set as being in a monitoring area for the left side of the subject vehicle M, and an omission of detection of other vehicles running in the lane L3 can be suppressed for the right side of the subject vehicle M.

In the example illustrated in FIG. 7, although a length LL of the left rear-side area A_{RL} and a length LR of the right rear-side area A_{RR} are not adjusted between a case in which the subject vehicle M runs at the running lane center CL and a case in which the subject vehicle M runs at a position deviating from the running lane center CL to the left side, the lengths may be adjusted on the basis of the deviating distance D.

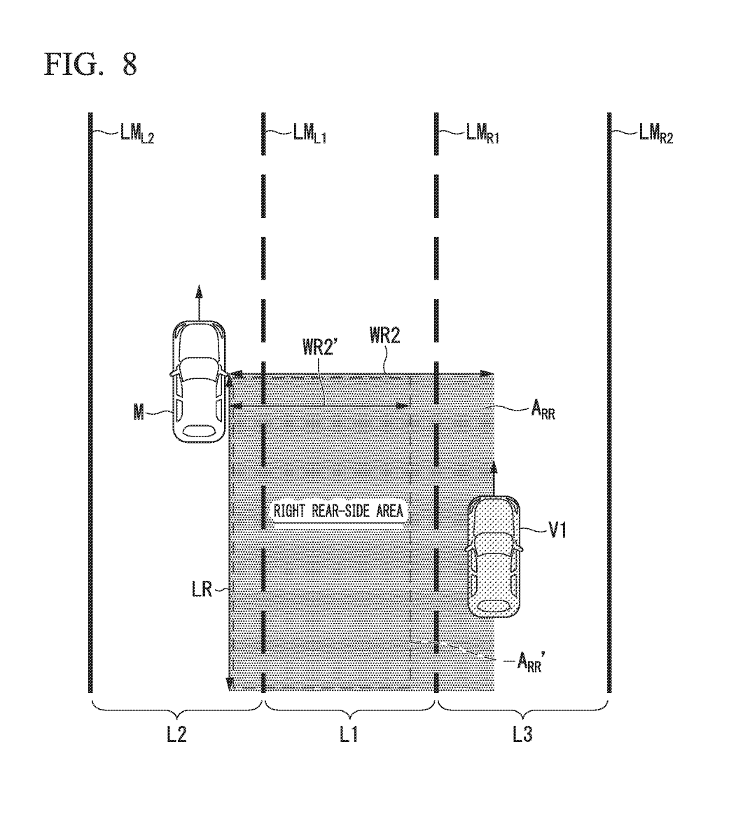

In a case in which the number of lanes recognized by the subject vehicle position recognizing unit 120 is equal to or greater than three, the monitoring area setting unit 131 may change the forms of the left rear-side area A_{RL} and the right rear-side area A_{RR} described above on the basis of a position of a running lane in which the subject vehicle M is running. FIG. 8 is a diagram showing a change in the form of a right rear-side area in a case in which a subject vehicle runs on a three-lane road. In the example illustrated in FIG. 8, the subject vehicle M is assumed as running in a left lane L2 among three lanes, and another vehicle V1 is assumed as running in a right lane L3 among the three lanes.

In a case in which it is determined that the acquired number of lanes is equal to or greater than three, and an adjacent lane is present in the vicinity of a lane in which the subject vehicle M is running, the monitoring area setting unit 131 changes the forms of the left rear-side area A_{RL} and the right rear-side area A_{RR}.

For example, as illustrated in FIG. 8, in a case in which the subject vehicle M is running in the lane L2, a right rear-side area A_{RR} extends to a lane L3 adjacent to an adjacent lane, and there is a likelihood that another vehicle V1 running in the adjacent lane L3 is erroneously detected. Thus, in a case in which the subject vehicle M is running in the lane L2, the monitoring area setting unit 131 sets a width WR2′ acquired by shortening the width WR2 of the right rear-side area A_{RR}. The width WR2′ is a width not exceeding a right partition line LM_{R1} of the adjacent lane L1. A distance from the subject vehicle M to the partition line LM_{R1}, for example, is recognized by the object recognizing device 16 or the external system recognizing unit 110. The width WR2′ may be set as being shorter than a length up to the partition line LM_{R1} such that another vehicle V1 running on the left side of the lane L3 is not a monitoring target. Accordingly, only the adjacent lane can be set as a monitoring target. In the example illustrated in FIG. 8, although description of the left rear-side area A_{RL} is not presented, the monitoring area setting unit 131, also for the left rear-side area A_{RL}, the monitoring area setting unit 131 may change the form of the area on the basis of a distance up to the left partition line LMR2 of the lane L2. Also in a case in which the running lane is a first lane or a second lane, the monitoring area setting unit 131 may set the left rear-side area A_{RL} and the right rear-side area A_{RR}.

The approach determining unit 132 determines whether or not another vehicle running in the left rear-side area A_{RL} or the right rear-side area A_{RR} is present among other vehicles recognized by the external system recognizing unit 110. In a case in which it is determined that another vehicle running in the left rear-side area A_{RL} or the right rear-side area A_{RR} is present, the approach determining unit 132 notifies the notification control unit 133 thereof.

The approach determining unit 132 determines whether or not there is a likelihood of a contact between the another vehicle and the subject vehicle M on the basis of a relative distance and a relative speed of the another vehicle present in the left rear-side area A_{RL} or the right rear-side area A_{RR}. For example, the approach determining unit 132 calculates a predicted time (marginal time) TTC until a contact of another vehicle, of which a relative distance is within a predetermined value, with the subject vehicle M occurs on the basis of the relative distance and the relative speed of the another vehicle present in the left rear-side area A_{RL} or the right rear-side area A_{RR}. The time-to-collision TTC, for example, is a time derived by dividing the relative distance by the relative speed (relative distance/relative speed). Then, in a case in which the TTC becomes a threshold or less, the approach determining unit 132 determines that there is a likelihood of being in contact with the another vehicle. In a case in which it is determined that there is a likelihood of being in contact with the another vehicle, the approach determining unit 132 executes notification control using the notification control unit 133 or executes contact avoidance control using the contact avoidance control unit 134.

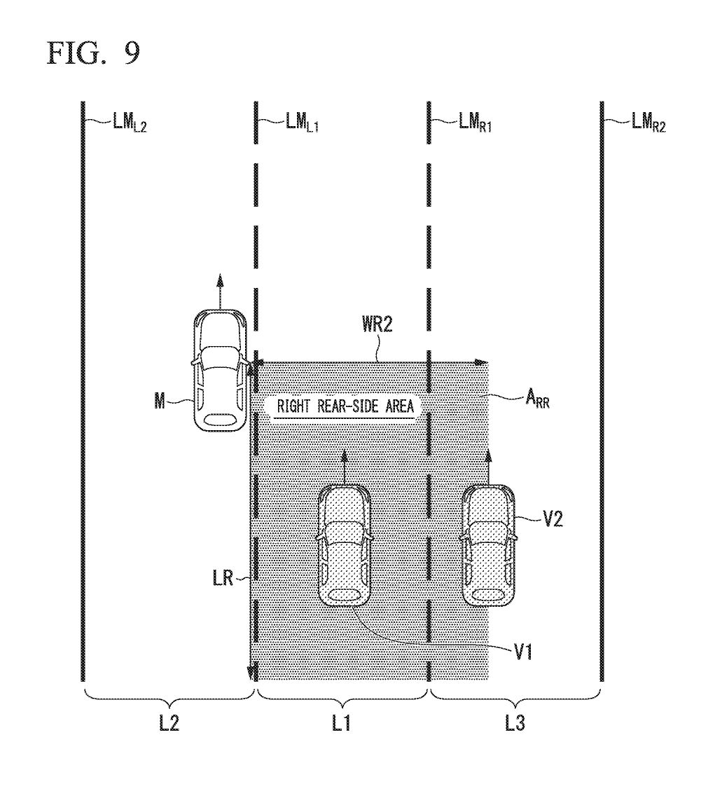

For example, in a case in which a plurality of other vehicles are present in the left rear-side area A_{RL} or the right rear-side area A_{RR}, the approach determining unit 132 identifies a vehicle closest to the subject vehicle M among the other vehicles as a monitoring target and performs approach determination for the identified vehicle. FIG. 9 is a diagram showing a view in which a plurality of other vehicles V1 and V2 are present inside a right rear-side area A_{RR}.

For example, in a case in which a subject vehicle M running in a left lane L2 among three lanes deviates from the lane center to the right side (the center lane L1 side), there are cases in which the right rear-side area A_{RR} extends up to a lane L3 adjacent to an adjacent lane thereof. In such cases, not only the vehicle V1 running in the lane L1 but also the vehicle V2 running in the lane L3 become monitoring targets. Thus, the approach determining unit 132 identifies a closest vehicle among the plurality of other vehicles present in the right rear-side area A_{RR} and performs approach determination for the identified vehicle as a monitoring target vehicle.

The approach determining unit 132 may learn a distribution of relative distances of other vehicles running in the vicinity of the subject vehicle M and identify a vehicle that is a monitoring target among the other vehicles on the basis of the learned distribution in a case in which it is difficult to identify the position of the subject vehicle M. In the example illustrated in FIG. 8, the approach determining unit 132 performs approach determination for a surrounding vehicle V1 as a monitoring target vehicle.

The notification control unit 133, for example, causes an in-vehicle device to output a predetermined notification on the basis of a result of the determination using the approach determining unit 132. Here, the predetermined notification, for example, is an image display using the display unit 22, an alarm using the speaker 24, a vibration of the steering wheel that is one example of the driving operator 40, a display of the predetermined image 60a using the BSI indicator 60, or the like. The in-vehicle device, for example, is the HMI 20, the driving operator 40, the BSI indicator 60, or the like. Details of the function of the notification control unit 133 will be described later.

The contact avoidance control unit 134 performs driving support of controlling the steering and the speed of the subject vehicle M for avoiding a contact with other vehicles on the basis of a result of the determination using the approach determining unit 132. For example, when a lane change is performed, the contact avoidance control unit 134, in a case in which it is estimated that there is a likelihood of being in contact with another vehicle running in a lane that is a lane change destination, executes lane departure suppressing control of controlling the steering not to allow the subject vehicle M to depart from its own lane, thereby performing driving support for contact avoidance. In the lane departure suppressing control, the speed of the subject vehicle M may be controlled in addition to the control of the steering.

The contact avoidance control unit 134, for example, includes a steering control unit 134A and a speed control unit 134B. In a case in which there is another vehicle estimated to have a likelihood of being in contact with the subject vehicle by the approach determining unit 132, the steering control unit 134A adjusts control amounts of the steering angle of the steering wheel and the steering torque such that the subject vehicle M avoids a contact with the another vehicle and outputs adjusted control amounts to the steering device 220.

In a case in which there is another vehicle estimated to have a likelihood of being in contact with the subject vehicle by the approach determining unit 132, the speed control unit 134B adjusts depression amounts of the acceleration pedal and the brake pedal such that the subject vehicle M avoids a contact with the another vehicle and outputs adjusted control amounts to the running driving force output device 200 and the brake device 210.

### [Example of Execution Situation of Driving Support Control]

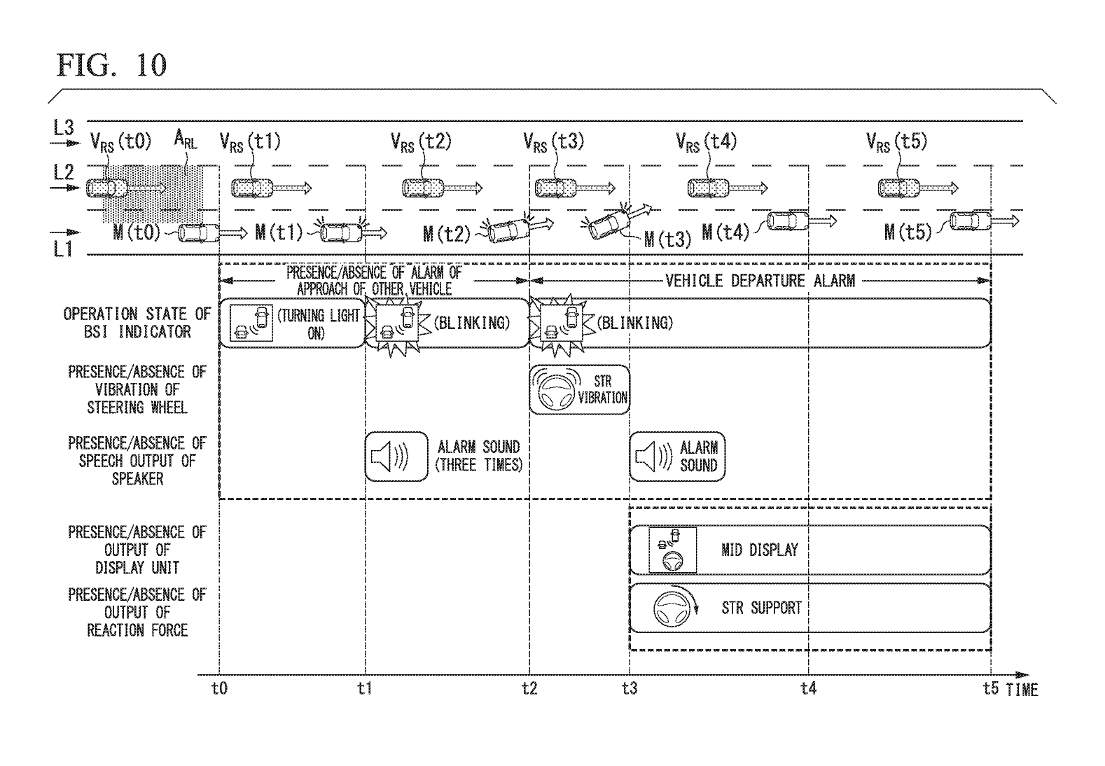

Hereinafter, an example of a situation in which driving support control is executed by the vehicle control device 100 will be described. FIG. 10 is a diagram showing control details of driving support control in a situation in which another vehicle V_{RS} approaches from the rear side of a subject vehicle M in an adjacent lane. In the drawing, running positions of a subject vehicle M running in a lane L1 and another vehicle V_{RS} running in a lane L2 at times t0 to t5 and control details of in-vehicle devices of the subject vehicle M at each of the times are illustrated. More specifically, as control details of the in-vehicle devices of the subject vehicle M, the operation state of the BSI indicator 60, presence/absence of the vibration of the steering wheel, presence/absence of a speech output of the speaker 24, presence/absence of an output of the display unit 22, and presence/absence of an output of a reaction force in the steering wheel are illustrated.

In this embodiment, the monitoring area setting unit 131 sets monitoring areas A_{RL} and A_{RR} on the rear side of the subject vehicle M on the basis of horizontal positions of its own lane L1 of the subject vehicle M at the times t0 to t5. In the example illustrated in FIG. 10, a left rear-side area A_{RL} at the time t=0 is illustrated. In the example illustrated in FIG. 10, the left rear-side area A_{RL} in which a lane adjacent to an adjacent lane L3 is not included is set on the basis of a horizontal position of the subject vehicle M in a lane L1 by the monitoring area setting unit 131.

For example, a time t0 illustrated in the drawing represents a time when the presence of another vehicle VRS is detected in the left rear-side area A_{RL} of the subject vehicle M. In this case, the notification control unit 133 displays the predetermined image 60a in a part of the mirror surface of the door mirror DMR2 by operating the BSI indicator 60 (“lighting” illustrated in FIG. 10). Accordingly, it can be notified to a vehicle occupant of the subject vehicle M that another vehicle V_{RS} is approaching from the rear side.

A time t1 represents a time when a vehicle occupant operates a turn signal lever that is one example of the driving operator 40 and operates a turn signal of the subject vehicle M for a lane change. In this case, a vehicle occupant of the subject vehicle M directs a lane change without recognizing the presence of another vehicle V_{RS}. Accordingly, even in a case in which the subject vehicle M is not close to a partition line, the notification control unit 133 blinks the predetermined image 60a displayed on the mirror surface of the door mirror DMR2 by controlling the BSI indicator 60 as a first alarm output at a time point of the time t1 (“blinking” illustrated in FIG. 10). The notification control unit 133 outputs an alarm sound a predetermined plurality of number of times (in the illustrated example, three times) to the speaker 24 at a timing at which the predetermined image 60a is blinked as a first alarm output. Accordingly, the vehicle occupant who has directed the lane change can be prompted more strongly than before the operation of the turn signal.

At the time t1, the approach determining unit 132 may determine whether or not a distance x to another vehicle V_{RS} is equal to or less than a threshold X or whether or not another vehicle VRS is present inside the left rear-side area A_{RL}, and TTC(x/2) is equal to or less than a first threshold TTC1, and, in a case in which the conditions described above are satisfied, and the winker operates, the notification control unit 133 may perform blinking of the predetermined image 60a described above and output of an alarm sound.

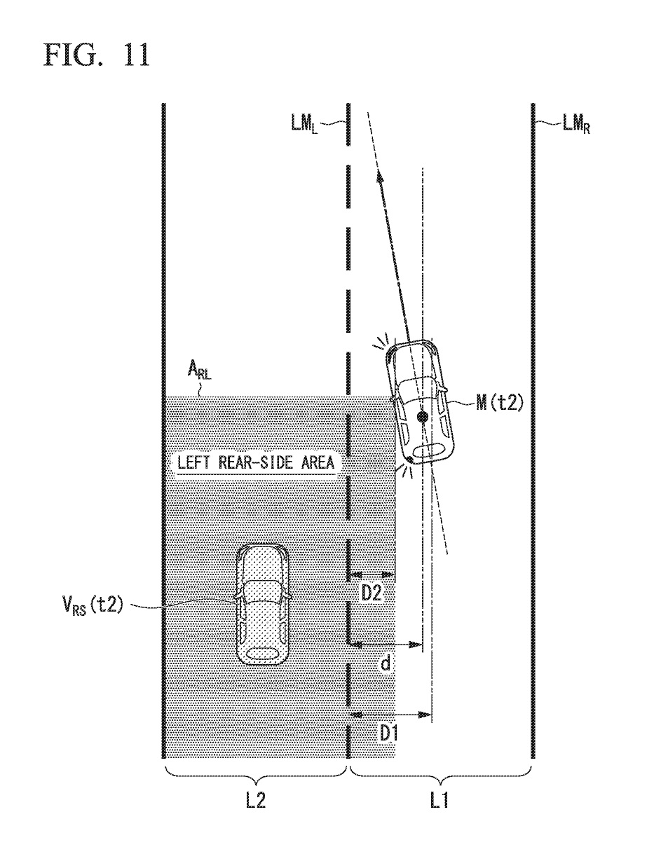

A time t2 represents a time when a vehicle occupant is to move the subject vehicle M from the lane L1 to the lane L2 by operating the steering wheel for performing a lane change. Here, FIG. 11 is a diagram showing a view of running of the subject vehicle M at the time t2. In the drawing, a partition line LML represents a left partition line in the advancement direction out of two partition lines partitioning the own lane L1, and a partition line LMR represents a right partition line in the advancement direction out of the two partition lines partitioning the own lane L1. In the example illustrated in the drawing, it is represented that the another vehicle VRS running in the left lane L2 is present within a predetermined distance from the subject vehicle M.

For example, until a distance d between the partition line LML and the center of gravity of the subject vehicle M becomes equal to or less than a first distance threshold D1, the approach determining unit 132 determines whether or not the subject vehicle M is close to the partition line LML. Instead of this, the approach determining unit 132 may determine whether or not an estimated lane departure time (time to lane crossing (TTLC)) that is a time until the subject vehicle M passes over the partition line is equal to or less than a first time threshold TTLC1 that is determined in advance. In a case in which it is determined that the subject vehicle M is close to the partition line LML until the distance d becomes the first distance threshold D1 or less or in a case in which it is determined that the estimated lane departure time TTLC is equal to or less than the first time threshold TTLC1, the approach determining unit 132 vibrates the steering wheel by operating a vibrator disposed in the steering wheel (an STR vibration illustrated in FIG. 10) as prior control for executing contact avoidance control using the contact avoidance control unit 134. Accordingly, a vehicle occupant can be promoted to run within the lane L1 by operating the steering wheel.

A time t3 represents a time when, after the steering wheel is vibrated, the subject vehicle M is further close to the partition line LML until there is no operation of a vehicle occupant on the steering wheel (the steering angle and the steering torque are less than thresholds), and the distance d between the partition line LML and the subject vehicle M is equal to or less than a second distance threshold D2 that is smaller than the first distance threshold D1. The time t3 may be a time when a predetermined time elapses after the steering wheel is vibrated. In such a case, the contact avoidance control unit 134 stops the vibration of the steering wheel and performs the lane departure suppressing control such that the subject vehicle M is returned to the lane center side as contact avoidance control. The second distance threshold D2, similar to the first distance threshold D1, is a distance in the vehicle width direction when a length determined in advance is taken toward the lane center side with reference to the partition line partitioning the own lane. For example, the second distance threshold D2 is set as a distance at which a part of the vehicle body of the subject vehicle M crosses over the partition line in a case in which the subject vehicle M becomes close to the partition line until the distance becomes the second distance threshold D2 or less.

The approach determining unit 132 may determine whether or not the estimated lane departure time TTLC(=d/v1) acquired by dividing the distance d by the lateral speed v1 of the subject vehicle M is equal to or less than the second time threshold TTLC2. In a case in which the estimated lane departure time TTLC is equal to or less than the second time threshold TTLC2, the contact avoidance control unit 134 performs steering control such that the subject vehicle M is returned to the lane center side. The second time threshold TTLC2, for example, may be set as a time shorter than the first time threshold TTLC1.

The notification control unit 133 causes an alarm sound to be output from the speaker 24 as a second alarm output and causes the display unit 22 to display an image representing that the subject vehicle M and another vehicle V_{RS} approach each other (multi information display (MID) illustrated in FIG. 10). The steering control unit 134A may output a reactive force to the steering wheel (STR support illustrated in FIG. 10).

At a time t4 represents a time when the subject vehicle M is returned to its own lane L1 in accordance with the contact avoidance control. In such a case, at a time point at which a predetermined time has elapsed after the subject vehicle M is returned to the own lane or at a time point at which the subject vehicle M has run a predetermined distance (a time t5 illustrated in FIG. 10), the notification control unit 133 stops the blinking display of the image 60a according to the operation of the BSI indicator 60 and ends the notification control of the MID display. The contact avoidance control unit 134 ends the contact avoidance control such as lane departure suppressing control.

### [Process Flow]

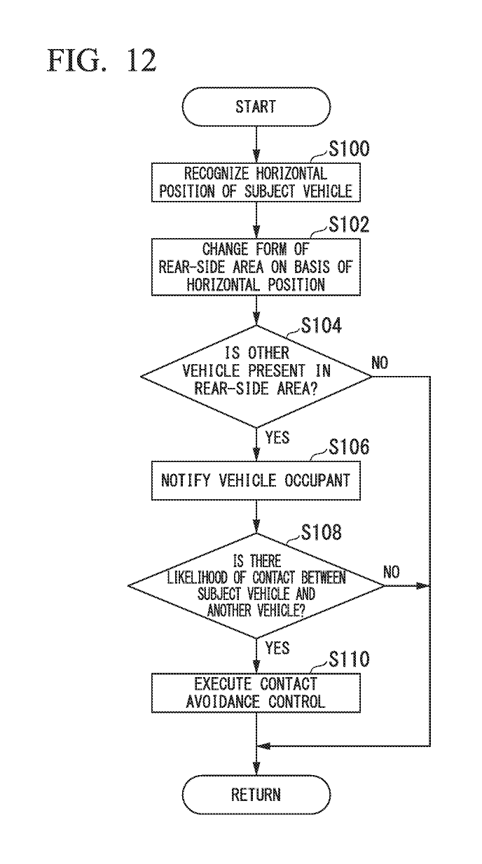

FIG. 12 is a flowchart showing one example of the flow of a vehicle control process according to the embodiment. For example, the process of this flowchart may be repeatedly executed at predetermined intervals or a predetermined timing. First, the subject vehicle position recognizing unit 120 recognizes a horizontal position of the subject vehicle M in a running lane (Step S100). Next, the other-vehicle monitoring control unit 130 changes the forms of rear-side areas on the basis of the horizontal position recognized by the subject vehicle position recognizing unit 120 (Step S102).

Next, the other-vehicle monitoring control unit 130 determines whether or not another vehicle is present in the rear-side areas (Step S104). In a case in which it is determined that another vehicle is present in the rear-side areas, the notification control unit 133 gives a notification representing an indication thereof to a vehicle occupant (Step S106). Next, the other-vehicle monitoring control unit 130 determines whether or not there is a likelihood of a contact between the subject vehicle M and the another vehicle (Step S108). In a case in which it is determined that there is a likelihood of a contact between the subject vehicle M and the another vehicle, the contact avoidance control unit 134 executes driving support (contact avoidance control) for avoiding a contact between the subject vehicle M and the another vehicle (contact avoidance control) (Step S110). In this way, the process of this flowchart ends. In the process of Step S104, in a case in which it is determined that another vehicle is not present in the rear-side areas or in a case in which it is determined that there is no likelihood of a contact between the subject vehicle M and the another vehicle, this flowchart ends.

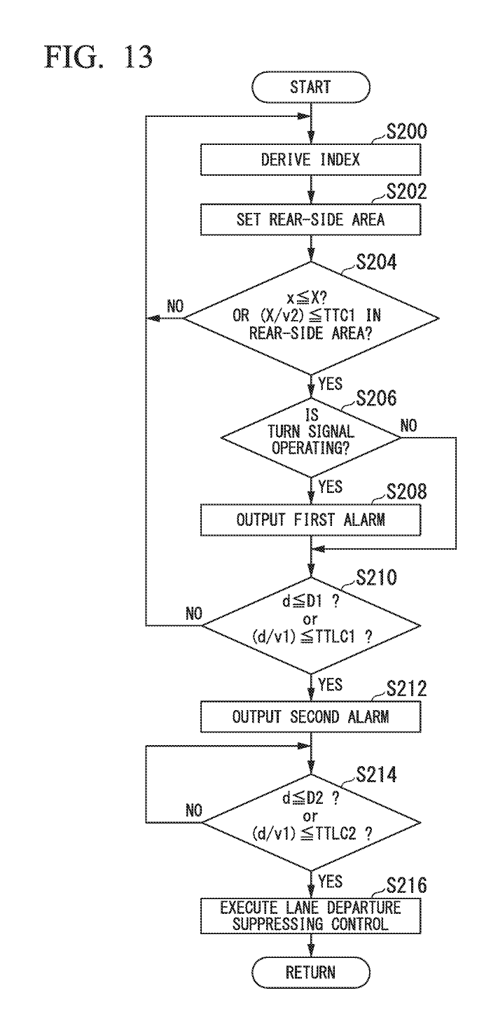

FIG. 13 is a flowchart showing one example of a detailed flow of a vehicle control process according to the embodiment. First, the other-vehicle monitoring control unit 130 derives an index that is necessary for the vehicle control of the subject vehicle M according to this embodiment (Step S200). In the process of Step S200, for example, a horizontal position of the subject vehicle M is calculated, a distance d between the subject vehicle M and a partition line of the lane is calculated, a lateral speed v1 of the subject vehicle M is calculated, a distance x between the subject vehicle M and another vehicle (for example, a back-side vehicle) is calculated, or a relative speed v2 between the subject vehicle M and another vehicle is calculated.

Next, the monitoring area setting unit 131 sets rear-side areas on the basis of the horizontal position of the subject vehicle M (Step S202). Next, the approach determining unit 132 determines whether or not the distance x to the another vehicle is equal to or less than the threshold X or whether or not TTC(x/2) is equal to or less than the first threshold TTC1 (Step S204). In a case in which it is determined that the distance x to the another vehicle is not equal to or less than the threshold X, and TTC(x/2) of the another vehicle is not equal to or less than the first threshold TTC1 inside the rear-side areas, the process is returned to the process of Step S200.

In a case in which it is determined that the distance x to the another vehicle is equal to or less than the threshold X, or TTC(x/2) is equal to or less than the first threshold TTC1 inside the rear-side areas, the approach determining unit 132 determines whether or not the turn signal is operating (Step S206). In a case in which it is determined that the turn signal is operating, the notification control unit 133 outputs the first alarm (Step S208). In the process of Step S206, in a case in which it is determined that the turn signal is not operating or after the process of Step S208, the approach determining unit 132 determines whether or not the distance d between the subject vehicle M, and the partition line is equal to or less than the threshold D1, or TTLC(d/v1) is equal to or less than the first threshold TTLC1 (Step S210). In a case in which it is determined that the distance d between the subject vehicle M and the partition line is not equal to or less than the threshold D1, and TTLC(d/v1) is not equal to or less than the first threshold TTLC1 of the TTLC, the process is returned to the process of Step S200. In a case in which it is determined that the distance d between the subject vehicle M and the partition line is equal to or less than the threshold D1, or TTLC(d/v1) is equal to or less than the first threshold TTLC1 of the TTLC, the notification control unit 133 outputs the second alarm (Step S212).

Next, the approach determining unit 132 waits until the distance d becomes the second distance threshold D2 or less or until the estimated lane departure time TTLC(=d/v1) becomes the second time threshold TTLC2 or less (Step S214) and executes lane departure suppressing control as one example of contact avoidance control when the distance d becomes the second distance threshold D2 or less, or when the TTLC becomes the second time threshold TTLC2 or less (Step S216). In the process of Step S214, for example, in a case in which the distance d becomes the first distance threshold D1 or more or the like, a process of returning to the process of Step S200 or ending the process of this flowchart may be performed.

### Modified Example

Here, a modified example of the vehicle control device 100 according to the embodiment described above will be described. For example, the monitoring area setting unit 131 of the other-vehicle monitoring control unit 130 extracts a width of its own lane in which the subject vehicle M is running from an image captured by the camera 10. Then, the monitoring area setting unit 131 may estimate a width of an adjacent lane of the own lane on the basis of the extracted width of the subject vehicle and change forms of the rear side areas of the subject vehicle M on the basis of the estimated width of the adjacent lane. Accordingly, by employing a simple configuration of the camera 10 and the radar 12, the forms of the rear side areas of the subject vehicle M can be changed.

In a case in which a plurality of other vehicles are present in the left rear-side area A_{RL} or the right rear-side area A_{RR}, the approach determining unit 132 of the other-vehicle monitoring control unit 130 may compare speeds of the other vehicles with each other and identify a vehicle, of which the speed is the highest, among the other vehicles as a monitoring target vehicle. Accordingly, determination of presence/absence of a likelihood of an approach to or a contact with another vehicle having a likelihood of an approach to or a contact with the subject vehicle M in a short time and the like can be performed.

In a case in which a plurality of other vehicles are present in the left rear-side area A_{RL} or the right rear-side area A_{RR}, the approach determining unit 132 may identify a vehicle that is a monitoring target on the basis of the behavior or each of the other vehicles. For example, the approach determining unit 132 recognizes the operating state of the turn signal and the advancement direction as the behaviors of the other vehicles and identifies a vehicle of which the turn signal of a direction corresponding to a direction in which the subject vehicle M is running operates, and the advancement direction is appropriate for the subject vehicle M side among the other vehicles as a vehicle that is a monitoring target. Accordingly, another vehicle of which a likelihood of an approach to the subject vehicle M is estimated to be high is set as a monitoring target, and determination of presence/absence of a likelihood of an approach to or a contact with the subject vehicle M and the like can be performed.

According to the embodiment described above, the vehicle control device 100 can detect other vehicles in an appropriate range on the rear side of the subject vehicle by changing the forms of the rear side areas on the basis of the horizontal position of the subject vehicle M. According to the embodiment, the vehicle control device 100 can suppress erroneous detection of another vehicle running in a lane adjacent to the adjacent lane of the own lane and suppress an omission of detection of other vehicles running in the adjacent lane also in a case in which the subject vehicle M is not running at the center of the own lane. Accordingly, for example, an erroneous operation of operating an alarm, contact avoidance control, and the like for a vehicle running in a lane adjacent to the adjacent lane can be suppressed. According to the embodiment, the vehicle control device 100 does not require a physical equipment used for correcting the angle of the radar, and a monitoring range can be adjusted by software.

### <Hardware Configuration>

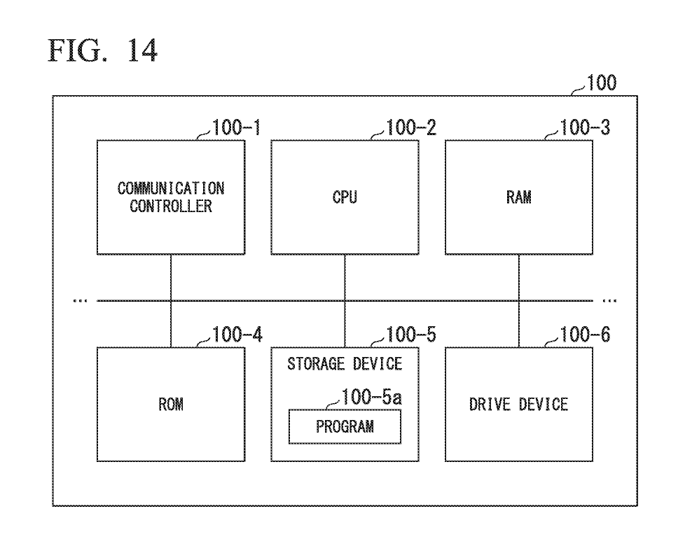

The vehicle control device 100 according to the embodiment described above, for example, is realized by a hardware configuration as illustrated in FIG. 14. FIG. 14 is a diagram showing one example of the hardware configuration of the vehicle control device 100 according to the embodiment.

The vehicle control device 100 has a configuration in which a communication controller 100-1, a CPU 100-2, a random access memory (RAM) 100-3, a read only memory (ROM) 100-4, a storage device 100-5 such as a flash memory or an HDD, and a drive device 100-6 are interconnected through an internal bus or dedicated communication lines. A portable storage medium such as an optical disc is loaded into the drive device 100-6. A program 100-5a stored in the storage device 100-5 or a program stored on a portable storage medium loaded into the drive device 100-6 is expanded in the RAM 100-3 by a direct memory access (DMA) controller (not illustrated in the drawing) or the like and is executed by the CPU 100-2, whereby each function of the vehicle control device 100 is realized. The program referred to by the CPU 100-2, for example, may be downloaded from another device through a network such as the Internet.

The embodiment described above can be represented as below.

A vehicle control device includes a storage device storing information and a hardware processor executing a program. In the storage device, the program described above is stored which is used for causing the hardware processor to execute: a recognition process of recognizing a horizontal position of the subject vehicle with respect to a lane in which the subject vehicle is running; and an other-vehicle monitoring control process of executing a predetermined operation in a case in which a state of another vehicle present on a rear side of the subject vehicle satisfies a predetermined condition and changing the predetermined condition on the basis of the recognized horizontal position.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognition unit recognizing a horizontal position of a subject vehicle with respect to a lane in which the subject vehicle is running; and
an other-vehicle monitoring control unit executing a predetermined operation in a case in which a state of another vehicle present on a rear side of the subject vehicle satisfies a predetermined condition and changing the predetermined condition on the basis of the horizontal position recognized by the recognition unit.

2. The vehicle control device according to claim 1,
wherein the predetermined condition includes presence of the other vehicle inside a predetermined area set on a rear side of the subject vehicle, and
wherein the other-vehicle monitoring control unit changes a form of the predetermined area on the basis of the horizontal position.

3. The vehicle control device according to claim 2,
wherein the predetermined area is set on each of left and right rear sides of the subject vehicle, and
wherein the other-vehicle monitoring control unit changes the predetermined area on the same side as a side to which the horizontal position deviates as being decreased and changes the predetermined area on the opposite side as being increased.

4. The vehicle control device according to claim 2, wherein the other-vehicle monitoring control unit changes forms of the predetermined areas such that the predetermined area set on each of the left and right rear sides of the subject vehicle covers a lane adjacent to a lane in which the subject vehicle is running in a widthwise direction.

5. The vehicle control device according to claim 2, wherein, in a case in which a plurality of other vehicles are present in the predetermined area, the other-vehicle monitoring control unit sets a vehicle among the other vehicles that is closest to the subject vehicle as a monitoring target.

6. The vehicle control device according to claim 2,
wherein the recognition unit recognizes the number of lanes in which the subject vehicle is running, and
wherein, in a case in which the number of lanes recognized by the recognition unit is three or more, the other-vehicle monitoring control unit changes a form of the predetermined area on the basis of the horizontal position recognized by the recognition unit.

7. The vehicle control device according to claim 2, further comprising:
a storage device in which map information is stored; and
a navigation device outputting information relating to a route to a destination of the subject vehicle on the basis of the map information stored in the storage device,
wherein the other-vehicle monitoring control unit acquires the number of lanes in which the subject vehicle is running from the map information and, in a case in which the acquired number of lanes is three or more, changes a form of the predetermined area on the basis of the horizontal position recognized by the recognition unit.

8. The vehicle control device according to claim 2, further comprising an imaging unit imaging a lane in which the subject vehicle is running,
wherein the other-vehicle monitoring control unit estimates a width of a lane adjacent to a lane in which the subject vehicle is running on the basis of an image captured by the imaging unit and changes a form of the predetermined area on the basis of the estimated width of the adjacent lane.

9. A vehicle control method executed by a computer mounted in a subject vehicle, the vehicle control method comprising:
recognizing a horizontal position of the subject vehicle with respect to a lane in which the subject vehicle is running;
executing a predetermined operation in a case in which a state of another vehicle present on a rear side of the subject vehicle satisfies a predetermined condition; and
changing the predetermined condition on the basis of the recognized horizontal position.

10. A computer-readable non-transitory storage medium having a program stored thereon, the program causing an in-vehicle computer to execute:
recognizing a horizontal position of the subject vehicle with respect to a lane in which the subject vehicle is running;
executing a predetermined operation in a case in which a state of another vehicle present on a rear side of the subject vehicle satisfies a predetermined condition; and
changing the predetermined condition on the basis of the recognized horizontal position.
